(19) United States
(12) Patent Application Publication
(10) Pub. No.: US 2026/0251508 A1
(43) Pub. Date: Aug. 27, 2026

(54) PHASE OTDR

(71) Applicant: NTT, Inc., Tokyo (JP)

(72) Inventors: Yoshifumi WAKISAKA, Musashino-shi, Tokyo (JP); Hiroshi TAKAHASHI, Musashino-shi, Tokyo (JP); Daisuke IIDA, Musashino-shi, Tokyo (JP); Yukihiro GOTO, Musashino-shi, Tokyo (JP); Yusuke KOSHIKIYA, Musashino-shi, Tokyo (JP)

(73) Assignee: NTT, Inc., Tokyo (JP)

(21) Appl. No.: 19/159,914

(22) PCT Filed: Mar. 3, 2023
(86) PCT No.: PCT/JP2023/008112

§ 371 Date: Aug. 26, 2025

(51) Int. Cl. G01K 5/56; G01L 1/24

(52) U.S. Cl. CPC G01K 5/56; G01L 1/242

(57) ABSTRACT

An object of the present disclosure is to provide a phase OTDR, a signal processing device, and a signal processing method capable of reducing an influence of a phase connection error and improving visibility of a signal indicating a vibration change or a temperature change.

According to the present disclosure, there is provided a signal processing device 14, which is included in a phase OTDR 301 and is configured to: measure a phase of backscattered light; express a temporal change of an amount of expansion/contraction occurred in an arbitrary section of an optical fiber as a difference between the phases at both ends of the section; perform unwrapping processing on the difference between the phases in a time axis direction and generate a waveform 40 of a phase Δθ_{c} after the unwrapping processing; generate a moving average waveform 43 by calculating a moving average of the waveform 40 by moving a window 41 having a window length W, corresponding to a predetermined time, in a time axis direction 42; and generate a corrected waveform 44 of a corrected phase difference Δθ_{c2} by subtracting the moving average waveform 43 from the waveform 40.

### TECHNICAL FIELD

The present disclosure relates to optical fiber sensing using a phase optical-time-domain-reflectometer (OTDR).

### BACKGROUND ART

A phase OTDR uses a method of measuring a strain change (vibration) and a temperature change causing expansion and contraction in a distributed manner by measuring an amount of expansion/contraction of an optical fiber in a distributed manner (refer to, for example, Non Patent Literature 1).

### CITATION LIST

### Non Patent Literature

Non Patent Literature 1: Y. Wakisaka, D. Iida, H. Oshida and N. Honda, “Fading Suppression of Φ-OTDR With the New Signal Processing Methodology of Complex Vectors Across Time and Frequency Domains”, in Journal of Lightwave Technology, vol. 39, no. 13, pp. 4279-4293, Jul. 1, 2021, doi: 10.1109/JLT.2021.3071159.

### SUMMARY OF INVENTION

### Technical Problem

FIG. 1 is a diagram illustrating a phase OTDR 301. In the phase OTDR 301, a light pulse, output from a light pulse generation unit 11, enters a measurement target optical fiber 50, and backscattered light is received by a scattered light receiving unit 13. A signal processing device 14 measures a phase of the light. A light receiving timing of the light corresponds to a distance from an entrance end of the light pulse of the measurement target optical fiber 50. Therefore, assuming that a timing at which the light enters the entrance end is t=0, the light receiving timing t and the distance z from the entrance end have a relationship of t=2zn/c. Here, n is a refractive index of the measurement target optical fiber 50, and c is the speed of light in a vacuum. By using the relationship, a phase θ(z) is calculated.

A pulse repeatedly enters at a time interval T, and thus, a phase change at each position z can be tracked. FIG. 2 is a diagram illustrating a phase change calculation method performed by the signal processing device 14.

### Step S01:

The entrance timing of the pulse is t=mT (m is an integer), and thus, the phase θ(z, mT+2zn/c) can be calculated.

### Step S02:

A temporal change in an amount of expansion/contraction occurred in a certain section [z−D/2, z+D/2] is calculated by a spatial difference Δθ in the following expression. A section length D is called a gauge length.

### [Math. 1]

$$Δθ ( z , mT + 2 zn / c ) = θ ( z + D / 2 , mT + 2 zn / c ) - θ ( z - D / 2 , mT + 2 zn / c ) \qquad ( 1 )$$

### Step S03:

The phase θ(z, mT+2zn/c) is wrapped between −π and +π, and A(z, mT+2zn/c) is also influenced by the wrapping. Thus, processing for phase connection (unwrapping) in a time axis direction is required.

In a method for phase connection, generally, in a state where a magnitude of a difference between a phase value at a reference timing mT+2zn/c and a phase value at the next timing (m+1)T+2zn/c should be larger than π, correction is performed by selecting an optimum integer l and adding 2πl to the phase value at the timing (m+1)T+2zn/c. Thereby, the magnitude of the difference between the phase value at the reference timing and the phase value at the next timing is equal to or smaller than π.

By performing the phase connection processing in a direction in which m sequentially increases from a timing of m=0, a corrected phase value Δθ_{c}(z+D/2, mT+2zn/c) is acquired over the entire measurement time. The subscript c indicates that correction is performed.

In a case where a value, which is obtained by converting an amount of expansion/contraction of the optical fiber between adjacent timings into a phase change, is smaller than n, a temporal change in the phase value Δθ_{c}(z+D/2, mT+2zn/c) after the phase connection processing quantitatively represents a change in the amount of expansion/contraction of the optical fiber.

In a process of calculating the phase θ(z, mT+2zn/c), precision and accuracy of measurement can be improved by encoding or frequency-multiplexing the entered pulse.

Further, the reference timing in the phase connection processing does not need to be set in the direction in which m increases from m=0. Any one of the timings can be set as a reference timing, and the phase connection processing can be sequentially performed in both a direction in which m increases from the reference timing and a direction in which m decreases from the reference timing.

After the scattered light receiving unit 13 receives scattered light signals of all the light pulses, the phase OTDR 301 can collectively perform step S01, and can perform step S02 and step S03 based on a result obtained in step S01 (offline processing).

On the other hand, the phase OTDR 301 can also perform step S01 to step S03 every time the scattered light receiving unit 13 receives the scattered light signal of one light pulse, that is, every pulse (real-time processing).

In a certain time period, when the phase connection processing is performed, the optimum 1 may be erroneously selected due to an influence of measurement noise associated with Δθ. In this case, the phase Δθ_{c} after the phase connection processing is performed, largely changes in the vicinity of the time period, and this leads to erroneous recognition as if to show that a large change occurs in the expansion/contraction state of the measurement target optical fiber 50 (refer to, for example, Non Patent Literature 1). Hereinafter, “erroneous selection of the optimum 1 due to the influence of the measurement noise associated with Δθ” will be described as “phase connection error”.

In a case where the phase connection error occurs, it is considered that the steady state of the expansion/contraction of the measurement target optical fiber greatly changes in time periods before and after the phase connection error, and this leads to a decrease in visibility (refer to Appendix 1) of measurement of the change in expansion/contraction of the measurement target optical fiber. Although simple differential filtering is also capable of removing a steep change caused by the influence of the phase connection error, it may remove even low frequency signals, which influences accuracy of the measurement. In addition, in a case where a high-pass filter having a large number of taps is used, the influence of the phase connection error is spread according to the number of taps, and this leads to erroneous detection that vibration which does not actually exist occurs over a time period having a wide range corresponding to the number of taps.

That is, the phase OTDR has a problem that it is difficult to prevent a deterioration in visibility of a signal indicating a vibration change or a temperature change due to occurrence of a phase connection error. Therefore, in order to solve the above problem, an object of the present invention is to provide a phase OTDR, a signal processing device, and a signal processing method capable of reducing an influence of a phase connection error and improving visibility of a signal indicating a vibration change or a temperature change.

### Solution to Problem

In order to achieve the above object, the phase OTDR according to the present invention monitors a vibration change or a temperature change, occurred in an optical fiber, by using a waveform obtained by subtracting, from a waveform of a temporal change of a phase after phase connection (unwrapping) processing in each optical fiber section, a waveform obtained by performing moving averaging on the temporal change of the phase in a time axis direction.

### (Transcription of Claim 1)

Specifically, according to the present invention, there is provided a phase OTDR including:
a light source which inputs a light pulse to a measurement target optical fiber;
a light receiving unit that receives backscattered light of the light pulse and outputs an electrical signal; and
a signal processing device that performs calculation on the electrical signal,
in which the signal processing device is configured to:
measure a phase of the backscattered light;
express a temporal change of an amount of expansion/contraction occurred in an arbitrary section of the measurement target optical fiber as a difference between the phases at both ends of the section;
perform unwrapping processing on the difference between the phases in a time axis direction and generate a waveform after the unwrapping processing;
generate a moving average waveform by calculating a moving average of the waveform after the unwrapping processing in a time axis direction with a window length for a predetermined time; and
generate a corrected phase difference waveform by subtracting the moving average waveform from the waveform after the unwrapping processing.

### (Transcription of Claim 3)

Further, according to the present invention, there is provided a signal processing device that performs calculation on an electrical signal that is generated by a phase OTDR, which includes a light source which inputs a light pulse to a measurement target optical fiber and a light receiving unit that receives backscattered light of the light pulse and outputs the electrical signal, the signal processing device being configured to:
measure a phase of the backscattered light;
express a temporal change of an amount of expansion/contraction occurred in an arbitrary section of the measurement target optical fiber as a difference between the phases at both ends of the section;
perform unwrapping processing on the difference between the phases in a time axis direction and generate a waveform after the unwrapping processing;
generate a moving average waveform by calculating a moving average of the waveform after the unwrapping processing in a time axis direction with a window length for a predetermined time; and
generate a corrected phase difference waveform by subtracting the moving average waveform from the waveform after the unwrapping processing.

### (Transcription of Claim 5)

Further, according to the present invention, there is provided a signal processing method that performs calculation on an electrical signal that is generated by a phase OTDR, which includes a light source which inputs a light pulse to a measurement target optical fiber and a light receiving unit that receives backscattered light of the light pulse and outputs the electrical signal, the signal processing method including:
measuring a phase of the backscattered light;
expressing a temporal change of an amount of expansion/contraction occurred in an arbitrary section of the measurement target optical fiber as a difference between the phases at both ends of the section;
performing unwrapping processing on the difference between the phases in a time axis direction and generating a waveform after the unwrapping processing; generating a moving average waveform by calculating a moving average of the waveform after the unwrapping processing in a time axis direction with a window length for a predetermined time; and
generating a corrected phase difference waveform by subtracting the moving average waveform from the waveform after the unwrapping processing.

An influence of a phase connection error can be reduced by subtracting, from a waveform of a temporal change of a phase after unwrapping processing, a waveform obtained by performing moving averaging on the temporal change of the phase, and thus, visibility of a signal indicating a vibration change or a temperature change can be improved. Therefore, the present invention can provide a phase OTDR, a signal processing device, and a signal processing method capable of reducing an influence of a phase connection error and improving visibility of a signal indicating a vibration change or a temperature change.

### (Transcription of Claims 2, 4, and 6)

Here, in a case of calculating the moving average, it is preferable to calculate a simple average of the waveform after the unwrapping processing for each block width shorter than the window length, and perform moving averaging on a value of the simple average within the window length.

In a case of performing moving averaging, it is not necessary to hold all phase data included in the window length on the memory. Thus, the memory capacity of the device can be reduced.

The signal processing device can also be realized with a computer and a program, and the program can be provided by being recorded on a recording medium or through a network.

Note that the above inventions can be combined as far as possible.

### Advantageous Effects of Invention

The present invention can provide a phase OTDR, a signal processing device, and a signal processing method capable of reducing an influence of a phase connection error and improving visibility of a signal indicating a vibration change or a temperature change.

### BRIEF DESCRIPTION OF DRAWINGS

FIG. 1 is a diagram illustrating a phase OTDR according to the present invention.

FIG. 2 is a diagram for explaining a phase change calculation method in the phase OTDR.

FIG. 3 is a diagram for explaining a concept of “visibility”.

FIG. 4 is a diagram for explaining a signal processing method according to the present invention.

FIG. 5 is a diagram for explaining effects of the present invention.

FIG. 6 is a diagram for explaining a moving averaging method.

FIG. 7 is a diagram for explaining a method of measuring a phase change in the phase OTDR according to the present invention.

### DESCRIPTION OF EMBODIMENTS

An embodiment of the present invention will be described with reference to the accompanying drawings. The embodiment to be described below is an example of the present invention, and the present invention is not limited to the following embodiment. Note that components having the same reference numerals in the present specification and the drawings indicate the same components.

### (Former Part of Claim 1)

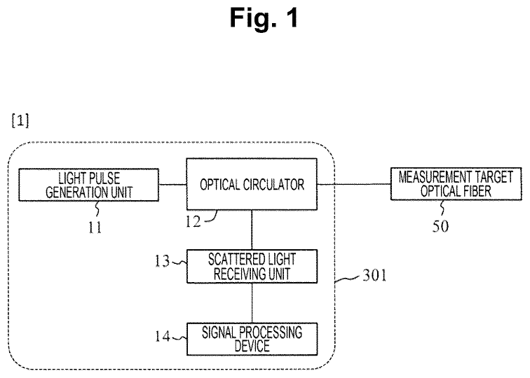

FIG. 1 is a block diagram illustrating a configuration of a phase OTDR 301 according to the present embodiment. The phase OTDR 301 includes:
a light source 11 which inputs a light pulse to a measurement target optical fiber 50;
a light receiving unit 13 that receives backscattered light of the light pulse and outputs an electrical signal; and
a signal processing device 14 that performs calculation on the electrical signal.

### (Latter Part of Claim 1)

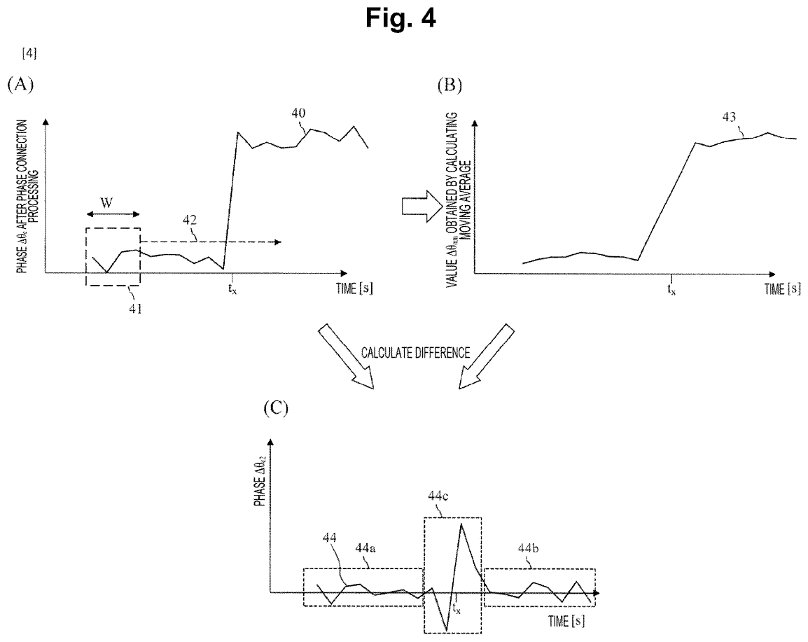

FIG. 4 is a diagram for explaining a signal processing method performed by the signal processing device 14 of the phase OTDR 301. The signal processing device 14 is configured to:
measure a phase of the backscattered light;
express a temporal change of an amount of expansion/contraction occurred in an arbitrary section of the optical fiber as a difference between the phases at both ends of the section;
perform unwrapping processing on the difference between the phases in a time axis direction and generate a waveform 40 of a phase Δθ_{c} after the unwrapping processing (FIG. 4(A));
generate a moving average waveform 43 by calculating a moving average of the waveform 40 after the unwrapping processing by moving a window 41 having a window length W, corresponding to a predetermined time, in a time axis direction 42 (FIG. 4(B)); and
generate a corrected waveform 44 of a corrected phase difference Δθ_{c2} by subtracting the moving average waveform 43 from the waveform 40 after the unwrapping processing (FIG. 4(C)).

The phase Δθ_{c} after the phase connection processing largely changes in the vicinity of a timing tx when a phase connection error occurs, and this leads to erroneous recognition as if to show that a large change occurs in the expansion/contraction state of the measurement target optical fiber 50. Against this, the signal processing device 14 improves visibility of measurement of a change in expansion/contraction of the measurement target optical fiber 50, by temporally localizing the influence of the phase connection error by the above-described signal processing.

The signal processing device 14 uses a fact that a steep change in the phase Δθ_{c} inherently does not occur in a time period in which the influence of the phase connection error is not included and that a difference occurs in an average level of Δθ_{c} in time periods before and after the influence of the phase connection error. Specifically, the signal processing device 14 corrects Δθ_{c} in a time period after the phase connection error such that the average level of Δθ_{c} in a time period after the phase connection error (after the timing tx) matches the average level of Δθ_{c} in a time period before the phase connection error (before the timing tx). In addition, there is no influence on the waveform of the change in expansion/contraction of the measurement target optical fiber 50 whatever a selected absolute value of the average level is; considering the above, the phases in all the time periods are preferably corrected so that the corrected average level becomes 0.

Here, there is a problem that it is not possible to predict a position and a timing at which a phase connection error occurs in advance. Therefore, for the sake of performing the signal processing described above, the average level of Δθ_{c} is calculated while a time window 41 having a preset time length W as illustrated in FIG. 4(A) is moved; a waveform 43 is obtained by performing moving averaging with the window length W as illustrated in FIG. 4(B). By subtracting the waveform 43 from the waveform 40 of Δθ_{c}, a waveform 44 of Δθ_{c2} in which the influence of the phase connection error is localized in time as in a period 44c is obtained (FIG. 4(C)). Note that a width of the period 44c is equal to the window length W. Further, the waveform 43 as the average value is subtracted from the waveform 40, and thus, the average level of Δθ_{c} becomes uniform in the time periods (periods 44a and 44b) before and after the phase connection error.

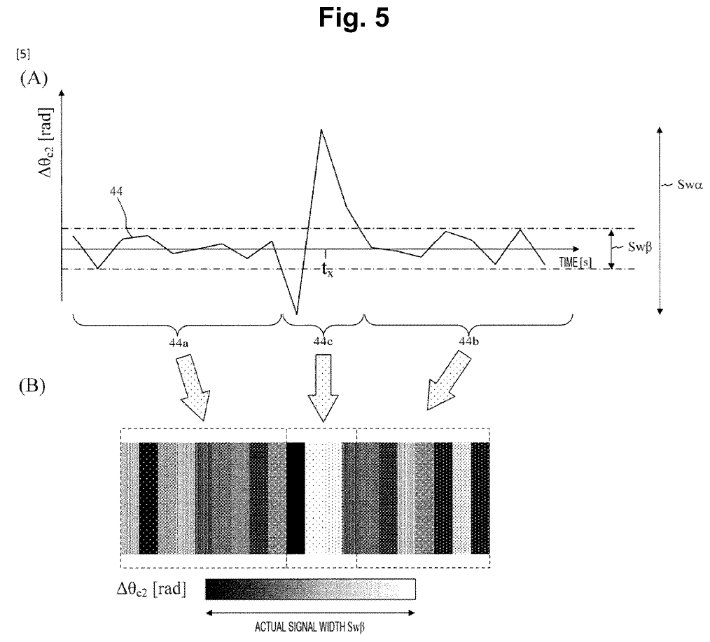

FIG. 5 is a diagram for explaining effects of signal processing performed by the signal processing device 14. FIG. 5(A) is a waveform of FIG. 4(C). FIG. 5(B) is a diagram obtained by converting the waveform of FIG. 5(A) into a waterfall diagram.

As illustrated in FIG. 5, by using Δθ_{c2}, the waterfall diagram, in which a zone corresponding an actual signal width Swβ is enlarged, can be expressed with regard to time periods (44a, 44b) other than a time period 44c, which has the influence of the phase connection error. Thus, visibility of the signal can be improved.

In this signal processing, the window length W to be used for the calculation of the average level is set to a length which is necessary and sufficient to such an extent that a signal indicating a change in a low frequency of interest (a change in expansion/contraction of the measurement target optical fiber 50) can be maintained. Thereby, the influence of the phase connection error can be suppressed to a minimum time width. Therefore, both a problem of removing even a signal indicating a change in a low frequency, which is caused by simple differential filtering, and a problem of a wide time period having an influence of a phase connection error, which is caused by a high-pass filter having a large number of taps, can be solved.

Further, by using the signal processing, the following effects can be obtained.

In the waveform 44 of FIG. 5(A) obtained by the signal processing, Swα is an apparent signal width in which the phase connection error is included, but a signal width due to a change in expansion/contraction of the measurement target optical fiber 50 is Swβ. Therefore, by setting the signal width Swβ to fit within a scale bar when converting the waveform into a waterfall image, it is possible to easily recognize a change in vibration as illustrated in FIG. 5(B). In addition, the influence of the phase connection error in the waterfall image appears to be localized to approximately the window length W. Thus, change in the expansion/contraction state of the measurement target optical fiber 50 before and after the phase connection error can also be captured.

Note that, in the waterfall image, a horizontal axis represents an elapsed time, a vertical axis represents a distance in the fiber, and a color bar represents a phase change. Here, the horizontal axis may indicate a distance in the fiber, and the vertical axis may indicate an elapsed time.

That is, in regard to applicability of the optical fiber distribution vibration measurement or the like using the phase OTDR, an actual change in vibration that is included in the output waterfall image as illustrated in FIG. 5(B) can be observed, with high visibility, with the influence of the phase connection error controlled.

### Example 1

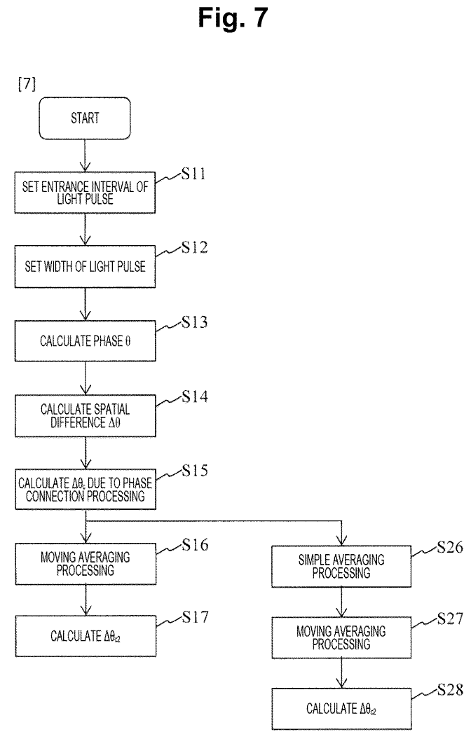

A measurement method of measuring an amount in expansion/contraction of the measurement target optical fiber 50 in a distributed manner by the phase OTDR 301 will be described with reference to FIG. 7 together with specific numerical values.

### Step S11:

In a case where a fiber length of the measurement target optical fiber 50 is L [m], a pulse entrance interval T [s] can be reduced to 2Ln/c. In monitoring some kind of change in expansion/contraction of an optical fiber, a change between adjacent points can be reduced by performing sampling at smaller time intervals. For this reason, an amplitude of the change in expansion/contraction for which normal phase connection processing can be applied increases. Thus, it is desirable to perform sampling at smaller time intervals from the viewpoint of a dynamic range of vibration. Therefore, the present example will be described below.

For example, in a case of monitoring a measurement target optical fiber 50 having a length of L=20 km, the pulse entrance interval T is set to 200 μs. Further, the present invention can also be applied to a case where the pulse entrance interval T is set to be larger than a lower limit value calculated from the fiber length L.

### Step S12:

The pulse width to be used for measurement is set to 2Rn/c [s] in a case where measurement is performed with spatial resolution R [m] for measurement.

For example, in a case where measurement is performed with spatial resolution of 10 m, the pulse width is set to 100 ns.

### Step S13:

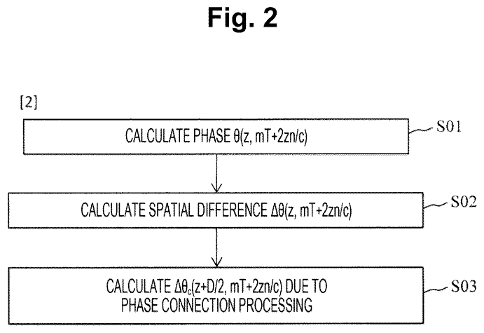

First, a phase θ(z, mT+2zn/c) is calculated from measurement data obtained by receiving the scattered light signal (refer to step S01 in FIG. 2).

For example, in an optical 90-degree hybrid of the scattered light receiving unit 13, the scattered light and local light which is separately prepared are multiplexed, and coherent light is detected. A complex vector, in which the in-phase component and the quadrature component obtained by the detection respectively correspond to a real part and an imaginary part, is calculated, and a phase θ(z, mT+2zn/c) is calculated as the argument of the obtained complex vector. Note that the present invention can be applied to any phase OTDR that outputs a phase regardless of on a specific phase acquisition method.

### Step S14:

Next, a spatial difference Δθ(z, mT+2zn/c) described in step S02 of FIG. 2 is calculated. Here, the gauge length D [m] is generally set to the same extent as the spatial resolution R [m]. For example, in a case of performing measurement with spatial resolution of 10 m, the gauge length is set to 10 m. Note that the present invention can also be applied to a case where the gauge length does not match the spatial resolution.

### Step S15:

Next, Δθ_{c}(z, mT+2zn/c) is obtained by performing phase connection processing on the spatial difference Δθ(z, mT+2zn/c) in a time direction for each z (refer to step S03 in FIG. 2).

### Step S16:

Next, a waveform Δθₘₘ(z, mT+2zn/c) is calculated by calculating a moving average (move mean) of Δθ_{c}(z, mT+2zn/c) with the window length W in a time direction for each z (refer to FIG. 4(A) and FIG. 4(B)).

Here, for the window length W, in a case of monitoring a frequency of the change in expansion/contraction of the measurement target optical fiber 50 to be measured up to F [Hz](a lower limit value of the frequency), W is set to the order of 1/F [s].

### Step S17:

Next, Δθ_{c2} is calculated by the following expression (refer to FIG. 4(C)).

Δθ_{c2}(z,mT+2zn/c)=Δθ_{c}(z,mT+2zn/c)−Δθₘₘ(z,mT+2zn/c).

For example, in a case of monitoring the frequency of the change in expansion/contraction of the measurement target optical fiber 50 up to 3 Hz, W is set to the order of 0.333 . . . [s]. In the above example, the pulse interval is 200 [μs], and W is set to the order of the number 1000 of pulses. In a case where a measurement distance in a general phase OTDR is approximately 20 [km], when the order of W/T=1000 is set, a waveform obtained by performing moving averaging can be obtained with sufficiently high accuracy with respect to the measurement noise. In addition, the time width having the influence of the phase connection error is also of the order of sub-seconds. Thus, when a waterfall diagram having a length of several seconds or longer is visualized, measurement can be performed without deteriorating the visibility.

### Example 2

In the present example, a measurement method of measuring an amount of expansion/contraction of the measurement target optical fiber 50 in a distributed manner and in real time will be described with reference to FIG. 7.

In the example 1 described above, when correcting a value of the spatial difference Δθ in a specific time period, a method of subtracting a value obtained by performing averaging with the window length W around the time period and performing calculation for each z is used. For this reason, it is necessary to hold all phase data included in the window length W on the memory. The present example is a procedure capable of reducing the memory capacity as compared with the example 1.

### (Equivalent to Claim 2)

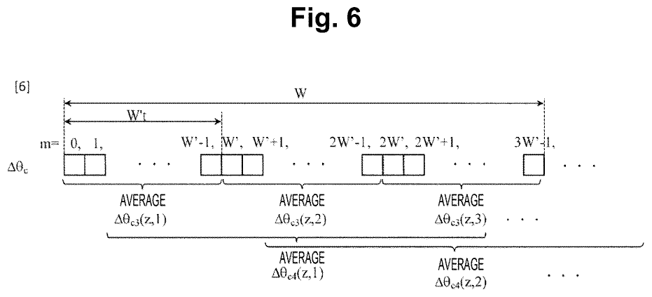

From step S11 to step S15, the present example is the same as the example 1. In the present example, step S16 and step S17 are step S26 to step S28. FIG. 6 is a diagram for explaining step S26 to step S28.

### Step S26:

The spatial difference Δθ_{c}(z, mT+2zn/c) after the phase connection processing is divided by a block width W′t. W′ is an integer, and t is a timing (an entrance timing or a light receiving timing of a light pulse). A simple average of Δθ_{c} for each light receiving timing included in the block width W′t of each block is calculated as Δθ_{c3}(z, W′). Note that FIG. 6 is an example of W/W′t=3.

### (Equivalent to Claim 2)

### Step S27:

Δθ_{c4}(z, mT+2zn/c) is obtained by calculating a moving average for Δθ_{c3}(z, W′) calculated in step S26. The number of points of Δθ_{c3} included in the moving average is W/W′t (3 in FIG. 6). That is, the window length when calculating the moving average is set to W as the time length (not the number of points).

### Step S28:

Next, Δθ₂ is calculated by the following expression.

Δθ_{c2}(z,mT+2zn/c)=Δθ_{c}(z,mT+2zn/c)−Δθ_{c4}(z,mT+2zn/c).

Here, the number of data points of Δθ_{c4} is reduced by 1/W′ times compared to the number of data points of Δθ_{c}(z, mT+2zn/c). Thus, in the subtraction processing of this step, the same value of Δθ_{c4} is used for only the W′ point. Specifically, data of an X-th point (X is an integer) of Δθ_{c4} is subtracted from data of Δθ_{c} as follows. [Math. 2]

$$m = ( {XW}^{′} ) - ( 3 {W}^{′} / 2 ) + ( W / 2 ) + Delay ∼ ( {XW}^{′} ) - ( {W}^{′} / 2 ) + ( W / 2 ) - 1 + Delay \qquad ( 2 )$$

“Delay” is an integer corresponding to a delay amount.

In the example of FIG. 6, Δθ_{c4}(z, 1) is an average of pieces of data of original Δθ_{c} in a case of m=0 to m=3W′−1. Thus, it is optimal to use for the subtraction of data of Δθ_{c} in a case of m=W′ to m=2W′−1. Here, from a relationship of the memory amount, Δθ_{c4}(z, 1) may be used for the subtraction of data of Δθ_{c} when m=W′+Delay to m=2W′−1+Delay.

### Effects of Present Example

In the present example, by calculating a simple average in the W′t block in advance in step S26 and then calculating a moving average in step S27, the memory capacity to be held can be reduced to W/W′t. Further, by providing a variable for Delay in step S28, an amount of data to be buffered for performing step S28 can also be reduced. Here, the time width in which the influence of the phase connection error is included is increased by W′t and Delay as compared with the example 1. Thus, W′t and Delay are designed such that the memory capacity is minimized.

### Appendix 1

The concept of “visibility” described in the present specification will be described.

The present invention is not processing of directly removing a large change due to the phase connection error.

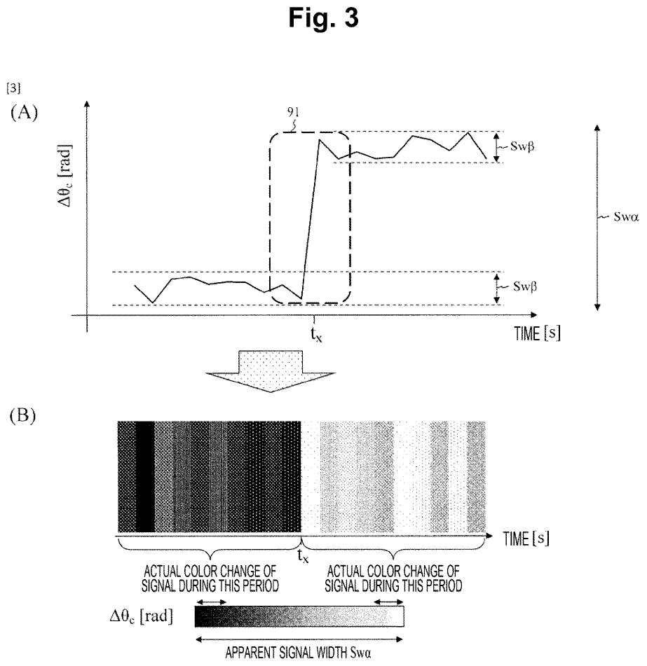

Thus, the concept of visibility is introduced and described. FIG. 3 is a diagram for explaining the concept of “visibility”. FIG. 3(A) is a diagram for explaining a temporal change in the phase value Δθ_{c} after the correction in step S03 of FIG. 2 is performed. A horizontal axis represents a time, and a vertical axis represents Δθ_{c}.

It is assumed that a phase connection error occurs at a timing tx. The corrected phase value Δθ_{c} greatly changes due to the influence of the phase connection error (reference numeral 91). Due to this phase connection error, although the actual signal width Swβ of Δθ is small, the apparent signal width Swα increases.

FIG. 3(B) is a diagram obtained by converting the waveform of FIG. 3(A) into a waterfall diagram. In FIG. 3(B), a horizontal axis represents an elapsed time in units of a cycle of a test light pulse, and a vertical axis represents an elapsed time shorter than one cycle of each test light pulse, that is, a distance in the measurement target optical fiber. Here, in FIG. 3(B), for the sake of convenience, the phase of only one point on the fiber at which a phase connection error occurs is extracted and displayed.

A value of a ratio Swβ/Swα is small, and thus, a change, in the entire color map, caused by the actual signal change is reduced. Therefore, the visibility (that is, identifiability and distinguishability of a vibration change or a temperature change occurred in the optical fiber) of the actual signal change (that is, a vibration change or a temperature change occurred in the optical fiber) is decreased.

### REFERENCE SIGNS LIST

11 Light pulse generation unit
12 Optical circulator
13 Scattered light receiving unit
14 Signal processing device
50 Measurement target optical fiber
301 Phase OTDR

1. A phase OTDR comprising:
a light source which inputs a light pulse to a measurement target optical fiber;
a light receiving unit that receives backscattered light of the light pulse and outputs an electrical signal; and
a signal processing device that performs calculation on the electrical signal,
wherein the signal processing device is configured to:
measure a phase of the backscattered light;
express a temporal change of an amount of expansion/contraction occurred in an arbitrary section of the measurement target optical fiber as a difference between the phases at both ends of the section;
perform unwrapping processing on the difference between the phases in a time axis direction and generate a waveform after the unwrapping processing;
generate a moving average waveform by calculating a moving average of the waveform after the unwrapping processing in a time axis direction with a window length for a predetermined time; and
generate a corrected phase difference waveform by subtracting the moving average waveform from the waveform after the unwrapping processing.

2. The phase OTDR according to claim 1,
wherein, in a case of calculating the moving average, the signal processing device calculates a simple average of the waveform after the unwrapping processing for each block width shorter than the window length, and performs moving averaging on a value of the simple average within the window length.

3. A signal processing device that performs calculation on an electrical signal that is generated by a phase OTDR, which includes a light source which inputs a light pulse to a measurement target optical fiber and a light receiving unit that receives backscattered light of the light pulse and outputs the electrical signal, the signal processing device being configured to:
measure a phase of the backscattered light;
express a temporal change of an amount of expansion/contraction occurred in an arbitrary section of the measurement target optical fiber as a difference between the phases at both ends of the section;
perform unwrapping processing on the difference between the phases in a time axis direction and generate a waveform after the unwrapping processing;
generate a moving average waveform by calculating a moving average of the waveform after the unwrapping processing in a time axis direction with a window length for a predetermined time; and
generate a corrected phase difference waveform by subtracting the moving average waveform from the waveform after the unwrapping processing.

4. The signal processing device according to claim 3, wherein, in a case of calculating the moving average, the signal processing device calculates a simple average of the waveform after the unwrapping processing for each block width shorter than the window length, and performs moving averaging on a value of the simple average within the window length.

5. A signal processing method that performs calculation on an electrical signal that is generated by a phase OTDR, which includes a light source which inputs a light pulse to a measurement target optical fiber and a light receiving unit that receives backscattered light of the light pulse and outputs the electrical signal, the signal processing method comprising:
measuring a phase of the backscattered light;
expressing a temporal change of an amount of expansion/contraction occurred in an arbitrary section of the measurement target optical fiber as a difference between the phases at both ends of the section;
performing unwrapping processing on the difference between the phases in a time axis direction and generating a waveform after the unwrapping processing;
generating a moving average waveform by calculating a moving average of the waveform after the unwrapping processing in a time axis direction with a window length for a predetermined time; and
generating a corrected phase difference waveform by subtracting the moving average waveform from the waveform after the unwrapping processing.

6. The signal processing method according to claim 5, wherein, in a case of calculating the moving average, a simple average of the waveform after the unwrapping processing is calculated for each block width shorter than the window length, and moving averaging is performed on a value of the simple average within the window length.
